(19) United States
(12) Patent Application Publication
(10) Pub. No.: US 2007/0183634 A1
(43) Pub. Date: Aug. 9, 2007

(54) Auto Individualization process based on a facial biometric anonymous ID Assignment

(76) Inventors: Jeffrey A. Dussich, New York, NY (US); Mcken King Hang Mak, Forest Hills, NY (US)

Correspondence Address: SUGHRUE MION, PLLC, 2100 PENNSYLVANIA AVENUE, N.W., SUITE 800, WASHINGTON, DC, 20037, US

(21) Appl. No.: 11/698,043

(22) Filed: Jan. 26, 2007

Related U.S. Application Data
(60) Provisional application No. 60/762,525, filed on Jan. 27, 2006.

(51) Int. Cl. G06K 9/00

(52) U.S. Cl. 382/118

(57) ABSTRACT

This invention is a method by which facial images are automatically grouped into unique individual collections based on the results of the existing facial recognition algorithm. The invention is used for the active grouping of facial images gathered from a sequence of image frames over a specified period of time. This organizational method allows for analytical processes not normally possible from the current facial recognition process.

The present application claims priority to U.S. Patent Application No. 60/762,525, filed on Jan. 27, 2006, the entire disclosure of which is incorporated herein.

This invention is generally directed to an enhancement of the processes involved in the field of biometric algorithms, specifically the biometric modality of facial recognition. The invention especially applies to facial image collection and the preparation for further processes such as identification and verification. This invention does not claim to modify the actual facial recognition algorithm that detects, extracts, measures and compares facial characteristics. The invention encompasses a process that utilizes the results of the existing facial recognition algorithm to produce a modified result set that enables certain external processes not possible without this invention. The processes enabled by this invention improve the overall usability and performance of facial recognition applications.

### BACKGROUND

Current facial recognition biometric algorithms detect and extract faces from an image frame generated by a photograph, a digital camera, or a streaming video source. The isolated facial image is then converted to a biometric template and matched against previously enrolled images, either to verify one's identity or identify the person against a database of images. Once the algorithm receives and processes the next image frame, it repeats the detection, extraction, and identification sequence, regardless of whether the next image frame contains a facial image of the same individual. The process is repeated indefinitely until it is manually stopped. The standard facial biometric process does not recognize the appearance of the same individual in sequential image frames.

Biometric processes are based on the likelihood or probability of a match between one set of physical characteristic measurements (“probe image”) and another set of physical characteristic measurements (“reference image”). The score or percentage result generated by a biometric process, for instance, 90%, signifies a 90% positive probability that the probe and gallery templates are identical. Each biometric modality possesses a “threshold,” above which a percentage match is considered “accurate,” and below which a percentage match is considered “inaccurate.”

The biometric modality of facial recognition is generally most susceptible to inaccurate results. In the 1-to-n environment, known as “identification,” one facial image is matched against a database of “n” images. The False Match Rate (FMR) and False Non-Match Rate (FNMR) enumerate inaccurate results of match activity. In the 1-to-1 environment, known as “verification,” one facial image is matched against another facial image to determine their likeness. The False Accept Rate (FAR) and False Reject Rate (FRR) enumerate inaccurate results of match activity. This has proven to be a difficult obstacle for facial recognition to overcome in trying to establish itself as a dependable (consistently accurate) biometric modality. Reasons for relatively high FMR and FRR are many, most often due to drastic variations in lighting conditions between the probe and reference images.

Aspects of this invention have most relevance in a facial recognition environment such as surveillance, as it can be safely assumed that the image capturing conditions will not be entirely ideal (identical to the environmental conditions of the gallery images) and the subject will not be actively cooperative or participatory in the image capturing process. As a basic overview of the facial recognition process (for such applications as surveillance and access control): the software receives a stream of video from a video source, detects the presence of a human face in each frame, extracts the facial image from the frame, converts the image to a biometric template, and matches the template to a database of previously enrolled images.

In an example of a surveillance environment, it is likely that the same person is within the camera's frame of view a period of time longer than a single image frame. Because of the existing facial recognition process of repeatedly detecting, extracting, and matching images, with no modification or intelligence in analyzing the results, the same person is matched to the database regardless of their repeated presence and the quality of each probe image. This leaves the system vulnerable to inaccurate results due to variations in subject pose and environment, and if the process is repeated, multiple occurrences of inaccurate results.

The invention described in the embodiments of this document improves the overall performance by analyzing the collected images from consecutive images frames prior to their submission for matching against one or more previously enrolled images. The auto-individualization process of grouping the facial images into unique individual collections improves the standard facial recognition biometric process by enabling numerous otherwise impossible external applications.

By grouping the facial images gathered from sequential frames into unique individual collections (based on the results of the facial recognition algorithm), the overall facial recognition process is improved, because multiple sequential facial images of an individual can be collected, which allows for easier visual inspection by human examiners; the number of false identification/matches can be reduced by matching multiple facial images of an individual to a database as opposed to only matching a single image; the false non-match rate is reduced by matching multiple facial images of an individual to a database as opposed to only matching a single image to the database; and the present invention provides the ability to use the numerical data of unique individual files for foot-traffic analysis and people counting.

### SUMMARY

This invention encompasses a method by which facial images are automatically grouped into unique individual collections based on the results of the facial recognition algorithm. The invention is used for the active grouping of facial images gathered from a sequence of image frames over a period of time. This organizational method allows for analytical processes not normally possible from the current facial recognition process.

The analytical processes facilitated by the auto-individualization process include, but are not limited to, a statistical analysis of the overall facial algorithm results of each of the images that comprise the unique individual collections against the match database. The statistical analysis results in a modified overall percentage score that improves the accuracy of the matching rates, by reducing the False Match Rates (FMR) and False Non-Match Rates (FNMR) in the 1-to-n biometric matching environment (“identification”), and reducing the False Accept Rate (FAR) and False Reject Rate (FRR) in the 1-to-1 biometric matching environment (“verification”).

### BRIEF DESCRIPTION OF THE DIAGRAMS

The accompanying diagrams illustrate the individual processes that are consistent with the concepts of the invention. The text below further describes the diagrams.

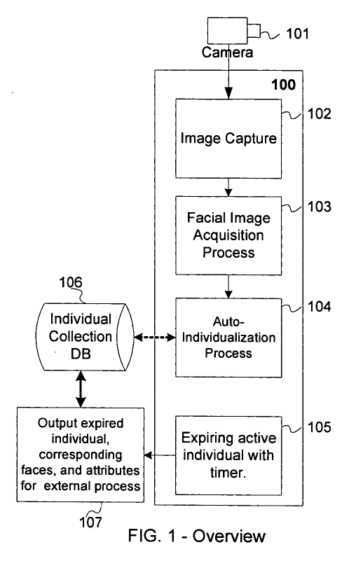

FIG. 1. A functional block diagram that provides an overview of the invention.

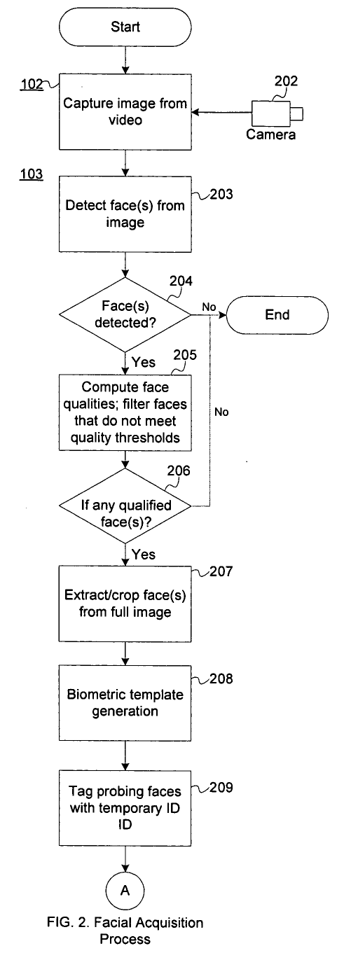

FIG. 2. A flow chart of the facial image acquisition process.

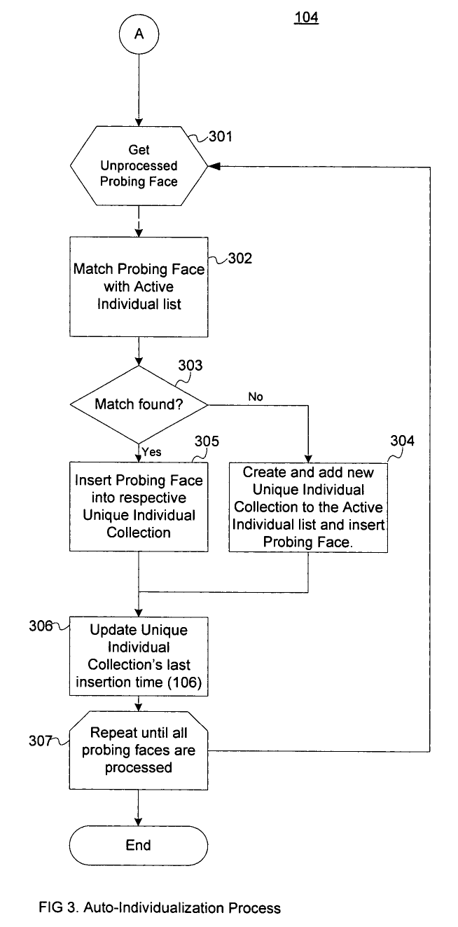

FIG. 3. A flow chart of the facial image grouping process based on the results of the facial recognition algorithm matches.

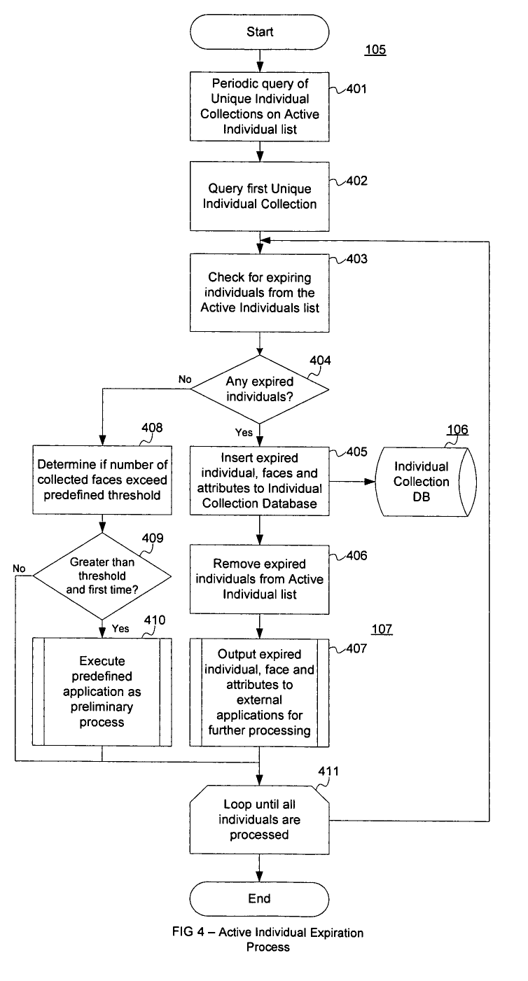

FIG. 4. A flow chart of the Active Individual expiration process.

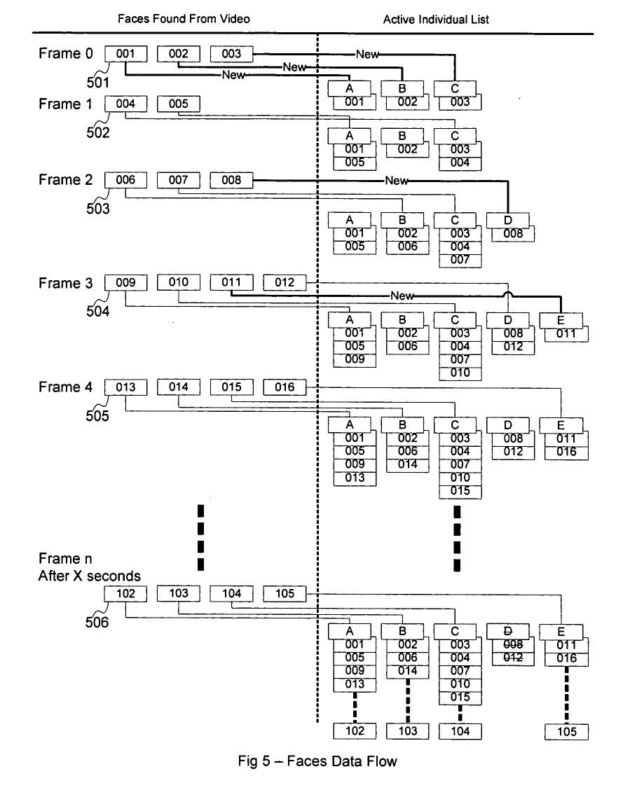

FIG. 5. A diagram of the facial image organization process, using the facial images collected in each frame.

### DETAILED DESCRIPTION OF EMBODIMENTS CONSISTENT WITH CONCEPTS OF THE INVENTION

This invention is embodied in a method by which facial images are automatically grouped into Unique Individual Collections based on the results of the facial recognition algorithm. The invention is used for the active grouping of facial images gathered from a sequence of image frames over a period of time. Throughout the following description, the reference numbers refer to corresponding elements in the drawings and diagrams featured above.

FIG. 1. The first diagram illustrates a procedural overview of the auto-individualization technique 100 constructed in accordance with the present invention. The system captures still images 102 in sequential frames from a video stream source 101 such as a PC-type USB camera (“webcam”) or standard surveillance camera. Each image is transferred to the facial acquisition process 103 where facial images of sufficient quality are extracted from the full image. The facial images are then transferred to the auto-individualization process 104 where the facial images are grouped into Unique Individual Collections. Each collection of images is placed on the Active Individuals list while it continues to receive additional images.

The Active Individual list contains a series of Unique Individual Collections, which are collections of biometrically unique individuals with similar faces and attributes such as (but not limited to) timestamps, face quality scores, distance between the eyes and templates for each extracted face. As a person passes through the camera's frame of view, the system captures their facial image, performs a quality check of their facial image, and groups the facial image according to the auto-individualization technique described above. Once the Unique Individual Collection stops receiving new image insertions for a period of time, the individual is removed from the Active Individual list and the identification or verification processes are initiated. In addition, a predetermined threshold of images can be configured to allow for preliminary identification or verification processes once the Unique Individual Collection reaches or exceeds said threshold.

The active individual expiration process 105 periodically queries the Active Individual list for Unique Individual Collections that have not received any new insertions of like facial images in a predetermined amount of time or have reached or exceeded their predetermined threshold of like facial images. When an active individual expiration occurs, the system transfers the expiring individual collection 107 into the Individual Collection Database 106 for external processes.

FIG. 2. The second diagram illustrates a flow chart of the facial acquisition process that performs the face detection, extraction, and preparation for biometric processing. Once the image is captured by the image capture process 102, the image is transferred to the face detection process 103 where the biometric algorithm determines whether or not there are any valid faces within the frame. If no faces are found within the frame 204, the process is terminated and waits to receive and analyze the next image.

If the system determines that a valid face is present 204, the system performs an image quality evaluation 205 based on the criteria of the biometric algorithm provider. Facial images that are determined to be under the quality threshold are removed 206. If there are no facial images of sufficient quality, the process is terminated and waits to receive and analyze the next facial image.

The remaining qualified facial images are then extracted and cropped out of the full image frame 207. The extracted facial images are submitted to the biometric template generation process 208, based on the procedure of the facial recognition biometric algorithm. Each facial image has a corresponding biometric template, which is a mathematical representation of the facial image.

The cropped face, template, and the associated attributes are given a temporary identification number 209 and are inserted into the process queue to prepare for the individualization process. The process of extracting/cropping face from full image frame 207, generating a biometric template 208 and tagging the probing face with a temporary ID 209 is repeated until all the probing faces have been tagged with a temporary ID 210.

FIG. 3. The third diagram illustrates a flow chart of the Auto-Individualization process 104 that automatically groups the facial images into individual collections based on the results of the facial recognition algorithm. The process begins by receiving the process queue from the Probing Face list 301. The face is then matched against the Unique Individual Collections on the Active Individual list 302 using the biometric-matching process provided by the facial recognition algorithm vendor.

If the biometric identification process results in a positive match, the Probing Face, template and corresponding attributes are inserted 305 into the respective Unique Individual Collection. If the biometric identification process does not result in a match, a new Unique Individual Collection 305 is added to the Active Individual list and the current Probing Face, template and corresponding attributes are inserted.

Once inserted into the new or existing Active Individual list, the system resets the expiration timer 306 and the most recent timestamp is used to activate the timer once again. The entire process is repeated 307 until all outstanding Probing Faces are individualized. If there are faces in queue, the process returns to the beginning 301. If there are no remaining faces in queue, the process is terminated and waits for the next Probing Face.

FIG. 4. The fourth diagram represents the expiration process for Unique Individual Collections on the Active Individual list 105. Unique Individual Collections on the Active Individual list must be consistently updated with new images in order to remain on the Active Individual list. Individual Collections that do not receive new images for a specified period of time are considered inactive by the expiration process 105.

The process begins by periodically querying the Unique Individual Collections on the Active Individual list 401. The periodic query interval is configurable based on the requirement. Once the process queries the Unique Individual Collection 402, the elapsed time of inactivity is calculated 403 by subtracting the timestamp of the latest image insertion 306 from the current time.

If 404 the elapsed time of inactivity exceeds the expiration time limit, the process 405 will insert the expired Individual Collection and its associated details into the Individual Collection Database 106 for archiving and availability for further processes. Once inserted into the Individual Collection Database 106, the process 406 will remove the expired individual from the Active Individual list and discontinue the auto-individualization process 104. The expired individual can then be transferred 407 to a predefined external application for further processing.

The Active Individual expiration process also allows for preliminary processing of Unique Individual Collections based on the Individual Collection reaching a certain threshold of images. This allows a specified number of the first collected images to be processed by an external application prior to the Individual Collection becoming fully inactive.

If the query of the Active Individual list 401 results in an Individual Collection that has not yet expired 404, the process 408 will determine whether the number of associated facial images in the Individual Collection are equal to or greater than the predetermined image threshold. If the number of images are greater than or equal to the predetermined image threshold and it is the first time that the Individual Collection has been queried 409, the individual is transferred 410 to a predefined external application for preliminary processing.

If the periodic query of the active individual list 401 receives an individual collection that has not yet expired 404 and the process 409 determines that the number of associated images is not equal to the predetermined image threshold, or if the process 409 determines that the Unique Individual Collection has already been transferred for preliminary processing, no action is taken and the process repeats 401.

Whether or not the system determines 404 that the current Individual Collection has expired, the process retrieves the next individual 411 from the Active Individual list. Each unprocessed Individual Collection is examined for inactivity 403 until all Individual Collections have been processed. The system then terminates and waits for updates to the Active Individual list.

FIG. 5. To further illustrate the invention, FIG. 5 represents an alternative data flow chart that provides an overview of the auto-individualization process. FIG. 5 represents an example of the relationship between each facial image captured by the system and the Unique Individual Collections of the Active Individual list. The Frame numbers listed vertically on the left side of the diagram represent the sequential frames of video captured 102 by the system. Each face received by the system is represented by a sequentially generated three-digit number. The right side of the diagram represents the Active Individual list. Each single-letter box represents a unique individual and thus a Unique Individual Collection.

Frame 0 (501)—Three (3) faces are captured from the frame and tagged as 001, 002 and 003. Because the Active Individual list is empty when the system starts, the three faces (001, 002, 003) become the first images of new active individuals 305. The new Active Individual list now has three Unique Individual Collections; each individual is associated with one facial image.

Frame 1 (502)—Two (2) faces are captured from the frame and tagged as 004 and 005. The facial recognition algorithm determines that facial image 004 corresponds with Unique Individual C and facial image 005 corresponds with Unique Individual A. After two image frames, Unique Individual A has two (2) associated faces, B has one (1) face, and C has two (2) faces.

Frame 2 (503)—Three (3) faces are captured from the frame and tagged as 006, 007 and 008. The facial recognition algorithm determines that facial image 006 corresponds with Unique Individual B, facial image 007 corresponds with Unique Individual C, and facial image 008 does not match with any of the existing Unique Individual Collections, thus starting the new Unique Individual Collection, D. After three image frames, Unique Individual A has two (2) associated faces, B has two (2) faces, C has three (3) faces, and D has one (1) face.

Frame 3 (504)—Four (4) faces are captured from the video and tagged as 009, 010, 011 and 012. The facial recognition algorithm determines that facial image 009 corresponds with Unique Individual A, facial image 010 corresponds with Unique Individual C, facial image 012 corresponds with Unique Individual D, and facial image 011 does not match any of the existing Unique Individual Collections, thus starting the new Unique Individual Collection, E. After four image frames, Unique Individual A has three (3) associated faces, Unique Individual B has two (2) faces, C has four (4) faces, D has two (2) faces, and E has one (1) face.

Frame 4 (505)—Four (4) faces are captured from the video and tagged as 013, 014, 015 and 016. The facial recognition algorithm determines that facial image 013 corresponds with Unique Individual A, facial image 014 corresponds with Unique Individual B, facial image 015 corresponds with Unique Individual D, and facial image 016 corresponds with Unique Individual E. After five image frames, Unique Individual A has four (4) associated faces, B has three (3) faces, C has five faces, D has two (2) faces, and E has two (2) faces.

Frame “n” will occur after “x” seconds, where “x” is defined as the inactivity time limit for the Unique Individual Collections. Frame “n” illustrates the expiration of a Unique Individual Collection, which results in its removal from the Active Individual list and preparation for further processing by an external application.

Frame n (506)—Four (4) faces are captured from the video and tagged as 102, 103, 104 and 105. The facial algorithm determines that facial image 102 corresponds with Unique Individual A, facial image 103 corresponds with Unique Individual B, facial image 104 corresponds with Unique Individual C, and facial image 105 corresponds with Unique Individual E. Because a sufficient amount of time has elapsed between the last image insertion into Unique Individual D and the current time, Unique Individual D has expired. Unique Individual D is removed from the active individual list. After Frame “n,” only unique individuals A, B, C, and E remain.

Examples of Usage

Surveillance Assistance System used in a sensitive or semi-sensitive area: The purpose of the application is the logging of facial images of everyone that accesses the area, allowing for facial image examination and analysis by the security or facility management team. A surveillance camera is positioned at the point of entry for a sensitive or semi-sensitive area. The auto-individualization process groups the images gathered by the surveillance camera into Unique Individual Collections. The system then outputs the individualized image collections 407 to an external a custom process that displays the expired individual's collected faces 406.

Manned Access Entry System (for Immigration Procedures at border crossings, reception desk in high-security facility, etc.): The purpose of the application is the identification of unwanted or suspicious persons entering a given area. A surveillance camera is placed adjacent to the Immigration Officer or reception desk attendant, directed toward the incoming flow of people traffic, enabling the camera to view the subjects in close range. The auto-individualization process outputs the individualized image collections 407 to an external custom application to perform facial recognition matching against a “watch list” database of unwanted or suspicious persons. The “watch list” matching process database can take place as a preliminary process 410 if the criteria are met 409, and as a final process once the unique individual is removed from the active individual list 407.

If the person is ejected for any reason, the corresponding collected images of the person can be enrolled into the “watch list” database. By collecting multiple images of the unique individual, the enrollment process is enhanced as the operator is provided with multiple potential enrollment images from which to choose. In addition, enrollment images collected and organized by the auto-individualization process are favorable for facial recognition, as the subject will likely have a more natural pose than a passport or ID photo.

Automatic Access Control (for portals, turnstiles, etc.): The purpose of the application is to use facial recognition to identify authorized persons and release a turnstile or door. A camera is placed near a door or turnstile, directed toward the natural path of the subject approaching the area. A custom identification process receives the request for preliminary matching after the Unique Individual Collection reaches its predetermined threshold of associated images 410. A positive match results in the release of the door or turnstile. An option for the external application is the integration of a card access or PIN ID system, enabling a 1-to-1 verification rather than a 1-to-n identification.

It is contemplated that one of ordinary skill in the art may make numerous modifications to the method, system, process or computer of the present invention without departing from the spirit and scope of the invention as defined in the following claims.

1. A method for recognizing facial images, comprising:
capturing a facial image;
executing a facial recognition process on the captured facial image;
classifying the captured facial image into one of unique individual collections based on the results of the facial recognition process;
wherein each of the unique individual collections comprises a plurality of facial images; and
wherein each of the plurality of facial images in the respective unique individual collection are related to same object.

2. The method of claim 1, wherein the facial image is captured from a video stream source.

3. The method of claim 1, wherein the facial image is captured in multiple sequential frames, the multiple frames being related to the same object.

4. The method of claim 1, wherein the plurality of facial images related to the same object are classified in the same unique individual collection.

5. The method of claim 1, compiling the unique individual collections into an active individuals list.

6. The method of claim 1, wherein the unique individual collection comprises 25 biometrically unique individuals.

7. The method of claim 6, wherein the biometrically unique individuals have similar attributes, including timestamps, face quality scores, distance between the eyes and templates.

8. The method of claim 1, wherein the captured facial image is extracted from a full image.

9. The method of claim 1, wherein the captured facial image is transferred to a facial acquisition process.

10. The method of claim 1, wherein, prior to executing the facial recognition process, face qualities are computed, based on the computation filtering facial images that do not meet quality thresholds.

11. The method of claim 1, wherein the facial image is tagged with a temporary identification.

12. The method of claim 11, wherein the temporary identification is a number related to the facial image, a biometric template, and unique attributes of the same object.

13. The method of claim 1, further comprising placing each collection of facial images on an active individuals list while additional images are being received.

14. The method of claim 13, wherein the active individuals list contains a series of unique individual collections.

15. The method of claim 14, wherein an identification process is initiated once an individual is removed from the active individual list.

16. The method of claim 15, wherein an individual is removed from the active individual list when an unique individual collection ceases to receive new images for a specified period of time.

17. The method of claim 1, further comprising matching a probing face with the active individual list.

18. The method of claim 17, wherein if the probing face is matched with the active individual list, the probing face is inserted into the respective unique individual collection.

19. The method of claim 18, further comprising updating the unique individual collection and resetting an expiration timer.

20. The method of claim 17, wherein if the probing face is not matched with the active individual list, a new unique individual collection is added and the probing face is added thereto.

21. The method of claim 20, further comprising updating the unique individual collection and resetting an expiration timer.

22. The method of claim 1, further comprising executing an active individual expiration process, wherein said process periodically queries the active individual list for unique individual collections that have not received new images for a specified period of time.

23. The method of claim 1, further comprising executing an active individual expiration process, wherein said process periodically queries the active individual list for unique individual collections that have received more facial images than the threshold limit.

24. The method of claim 16, wherein the expiring unique individual collection is transferred to the individual collection database for external processing.

25. The method of claim 1, further comprising an expiration process for unique individual collections on the active individual list,
wherein unique individual collections that do not receive new images for a specified period of time are identified as inactive, and
wherein said inactive collections are removed from the active individual list.

26. The method of claim 25, wherein the inactive collection removed is transferred to a predefined external application for further processing.

27. A system for recognizing facial images comprising:
a capturing module which captures an image;
a process for executing a facial recognition algorithm on the captured image;
a classification module that classifies the captured image into one of unique individual collections based on the results of the facial recognition algorithm;
wherein each of the unique individual collections comprises a plurality of facial images; and wherein each of the plurality of facial images are related to a same object.

28. A computer comprising a CPU processor, a display, memory, and input/output, wherein the computer is connected to a database storage unit and receives information from a camera, wherein the computer is configured to:
capture a facial image;
execute a facial recognition process on the captured facial image;
classify the captured facial image into one of unique individual collections based on the results of the facial recognition process;
wherein each of the unique individual collections comprises a plurality of facial images; and
wherein each of the plurality of facial images in the respective unique individual collection are related to same object.

29. A computer-readable medium storing instructions, the instructions comprising:
directing a computer to capture an image;
directing a computer to execute a facial recognition algorithm on a captured image;
directing a computer to classify the captured image into one of unique individual collections based on the results of the facial recognition algorithm, wherein each of the unique individual collections comprises a plurality of facial images, and wherein each of the plurality of facial images are related to same object.
